(19) United States
(12) Patent Application Publication
(10) Pub. No.: US 2010/0024739 A1
(43) Pub. Date: Feb. 4, 2010

(54) Device for Cleaning Aquarium Windows

(76) Inventor: Geert-Jan Bakker, Oud-Turnhout (BE)

Correspondence Address: HONIGMAN MILLER SCHWARTZ & COHN LLP, 444 WEST MICHIGAN AVENUE, KALAMAZOO, MI, 49007-3714, US

(21) Appl. No.: 12/226,998

(22) PCT Filed: Mar. 27, 2007
(86) PCT No.: PCT/EP2007/052921

§ 371 Date: Feb. 16, 2009

(30) Foreign Application Priority Data
May 4, 2006 (DE) 10 2006 021 134.0
May 15, 2006 (DE) 10 2006 022 932.0

(51) Int. Cl. A01K 29/00

(52) U.S. Cl. 119/264

(57) ABSTRACT

The invention relates to a device for cleaning aquarium windows (5), in particular the inside thereof, comprising an internal element (1), which can be positioned on the inside of the aquarium window (5) and has a surface (Ib) directed towards the inside of the aquarium window (5), and also comprising an external element (2), which can be positioned on the outside of the aquarium window (5) and has a surface (2b) directed towards the outside of the aquarium window (5), wherein the internal and external elements (1, 2) attract one another under the action of magnetic force, in which case movement of the external element (2) along the aquarium window (5) causes the internal element (1) to follow this movement. The device is characterized according to the invention in that at least one cleaning edge (3) is arranged on the surface (Ib) of the internal element (1), this surface being directed towards the inside of the aquarium window (5). The invention also relates to a method of cleaning aquarium windows (5), in particular the inside thereof.

The invention relates to a device for cleaning aquarium windows, in particular the inside thereof, comprising an inner element to be positioned on the inside of the aquarium window with a surface facing the inside of the aquarium window, as well as an outer element to be positioned on the outside of the aquarium window with a surface facing the outside of the aquarium window, wherein the inner and outer elements attract one another under the action of magnetic force, so that a movement of the outer element along the aquarium window causes the inner element to follow this movement. Furthermore, the invention relates to a method for cleaning aquarium windows, in particular the inside thereof.

A device and a method of the type mentioned above for cleaning the inside of aquarium windows using magnets is known from GB 2 105 977 A. The device described therein comprises an inner element, which generates a magnetic field, and a pair of cleaning surfaces which are substantially perpendicular with respect to one another. Furthermore, the device comprises an outer element which also generates a magnetic field, with which the inner mechanism can be guided along the aquarium window. When using this device, the inner mechanism is positioned on the inner side of the aquarium window and the outer mechanism on the outside of the aquarium window in such a way that as a result of the mutually influencing magnetic forces of the outer and the inner element, the two elements adhere to the aquarium window. If the outer element is then moved along the aquarium window, the inner element follows the movement of the outer one and in the process cleans the inside of the aquarium window. A comparable device is also known from EP 1 139 729.

The two devices mentioned above have in common that the respective inner mechanism has a flat cleaning surface, with which aquarium windows which are also flat can be effectively cleaned. The devices mentioned above fail, however, if the aquarium window to be cleaned is no longer flat, but has a curvature.

The present invention is therefore based on the object of providing a device of the type mentioned at the outset, with which not only flat aquarium windows can be cleaned effectively, but which also allows the cleaning of differently curved, in particular spherically curved aquarium windows. Furthermore, a method for cleaning flat and curved, in particular spherically curved, aquarium windows is to be provided.

The object is achieved with a device for cleaning aquarium windows according to the preamble of claim 1 in that at least one cleaning edge is arranged on the surface of the inner element facing the inside of the aquarium window.

Advantageous configurations of the invention are described in the dependent claims 2 to 18.

Owing to a transition implemented according to the invention from a cleaning surface, such as is provided in the devices known from the prior art, to a cleaning edge, it is now possible, in addition to flat aquarium windows, to also clean windows of the type which have a curvature with a uniform radius or else different radii or which are composed of flat and curved portions. The mode of action of the cleaning edge in relation to the dirt to be cleaned off located on the aquarium window is comparable with that of a windscreen wiper or a squeegee.

The outer edge of a planar portion, for example an annular planar portion, which is arranged on the surface of the inner element facing the inside of the aquarium window, can also be regarded as a cleaning edge in the sense of the present invention. Furthermore, contact lines, which are formed, for example on the contact point between the strongly curved and flat or comparatively slightly curved surfaces, can also be regarded as an edge in the sense of the invention.

In the case of particularly stubborn dirt, it is advantageous according to a first configuration of the invention to configure the at least one cleaning edge to be undulating, jagged or with a different type of rough contour.

If aquarium windows are preferably cleaned with a certain surface geometry, it may be sensible to design at least one cleaning edge to be curved. The radius of curvature may in this case lie in any desired plane. It preferably lies in a plane parallel or perpendicular to the plane of the movement of the inner element.

According to a particularly advantageous configuration of the invention it is provided that the at least one cleaning edge is formed by a closed curved line, which is provided on the surface of the inner element facing the inside of the aquarium window. A closed curved line ensures that, in particular in the case of uniformly spherically curved aquarium window surfaces, the cleaning edge rests flush on the window surface to be cleaned over its entire length, which allows excellent cleaning results to be achieved. This closed curved line is preferably round, in particular circular.

According to an advantageous configuration of the invention, the one cleaning edge is configured as an upper edge of an edge element. This preferably has a triangular, in particular isosceles triangle-shaped, cross-section. This ensures adequate strength and stability of the cleaning edge even with intensive use of the device according to the invention.

From the point of view of usability and economy it is sensible to produce the cleaning edge from an adequately strong and simultaneously economical material. Particularly preferred here is the use of a polymeric plastics material, in particular ethylene vinyl acetate or polypropylene. Furthermore, felt-like, nonwoven-like and/or textile-like materials are also possible, such as, for example, the hook or loop side of a hook-and-loop fastener.

According to a further advantageous configuration of the invention, it is provided that the cleaning edge is configured as the outer edge of an annular surface portion arranged on the surface facing the inside of the aquarium window. Good cleaning results are achieved with this, in particular in the case of slightly curved aquarium windows.

As in the case of a curved or at least partially curved inner surface of the aquarium window to be cleaned, the outer surface thereof is generally also correspondingly curved or partially curved, according to a further configuration of the invention, it is sensible to also arrange an edge with the above-described properties on the surface of the outer element facing the outside of the aquarium window. As a result, it is primarily ensured that the outer element also rests flush on the aquarium window by way of the edge arranged on the surface facing the outside of the aquarium window, so that a uniform guidance, free of interruption, of the outer element on the outer surface of the aquarium window, and therefore of the inner element on the corresponding inside, is ensured.

According to a further configuration of the invention it is provided that the surface of the inner element facing the inside of the aquarium window and/or the surface of the outer element facing the outside of the aquarium window is formed so as to be at least partially concave. It is possible, owing to this concave forming, to also clean more strongly curved contours of the aquarium window to be cleaned with the cleaning edge provided according to the invention, without collisions occurring between the window surface and, depending on the curvature of the window, the inner element or the outer element, as a result of which, in the case of the inner element, the cleaning edge would be lifted from the surface to be cleaned, which would lead to an interruption of the cleaning and therefore to a strongly impaired cleaning result, at least locally.

A further problem in cleaning aquarium windows is that in the event of an interruption of the magnetic attraction between the inner and outer element, the inner element detaches from the inside of the aquarium window to be cleaned and drops to the bottom of the aquarium, from where it can only be recovered with effort. According to a further advantageous configuration of the invention, it is therefore provided that the inner element is constructed in such a way that it floats on the liquid contained in the aquarium as soon as the magnetic force is removed. As a result, it is ensured that the inner element immediately rises after possibly accidental interruption of the magnetic attraction between the outer and inner element to the generally easily accessible surface of the liquid contained in the aquarium. From there, after the cleaning cycle has ended, it can be simply removed or brought back again to the window surface to be cleaned in such a way that it again arrives in the attraction region of the magnetic field of the outer element so that the cleaning can be continued again.

Specifically, the desired floating behaviour of the inner element can be implemented by various measures to be carried out alternatively or additionally. Thus, on the one hand, it is possible for the inner element to comprise an air chamber which gives the inner element buoyancy. Likewise, the inner element, to achieve buoyancy, may contain a material, which has a lower density than the liquid present in the aquarium. Suitable materials are, for example, plastics material, foam, wood or the like, it ultimately being decisive that the density of the inner element to be positioned on the inside of the aquarium window is in total lower than the density of the liquid present in the aquarium, so a buoyancy of the inner element in the liquid is ensured. If a material of this type is used, a leak in the air chamber of the inner element, which, for example, would allow water to penetrate into the inner element, does not immediately lead to the sinking thereof to the bottom of the aquarium.

According to a further particularly preferred embodiment of the invention it is provided that both the inner element and the outer element are provided with at least one magnet. As a result, a particularly strong connection is ensured between the inner and outer element, which is important, in particular, if very thick aquarium windows are to be cleaned. A very strong magnetic field is also required if a region of the aquarium window close to the base is to be cleaned with the inner element, as the force exerted vertically on the inner element by the column of liquid is substantially greater close to the base than close to the liquid surface. Moreover, when using magnets in the two elements, the magnetic connection between the elements is not even interrupted if the cleaning is to take place around certain obstacles, such as, for example, pumps, water plants or decorative stones, wherein the spacing between the inner and outer element may temporarily increase.

The magnets may be arranged differently in the inner and outer element. It is particularly advantageous if both the inner element and the outer element are provided in each case with four magnets arranged next to one another in pairs, the diametrically opposing magnets having the same polarity in each case.

According to a further configuration of the invention, which is alternative to the above, it is provided that the inner element contains a magnetisable material. Specifically, the inner element may, for example, contain an iron plate or another ferromagnetic material. By dispensing with magnets of its own, the inner element may be manufactured with a lower weight and at low costs.

To carry out the cleaning of aquarium windows in a convenient manner it is important for the generally manually guided outer element to lie well in the hand. For this purpose, it is provided according to a further advantageous configuration of the invention that the outer element has a housing, which is provided with at least one recessed grip.

The object mentioned above is also achieved according to the invention by a method for cleaning aquarium windows according to the preamble of claim 17 in that a device according to any one of claims 1 to 17 is used. The method according to the invention is particularly suitable for the cleaning of spherically curved aquarium windows. Moreover, that which was stated above applies to the advantages of the method according to the invention.

The invention will be described in more detail below with the aid of drawings showing embodiments. In the drawings:

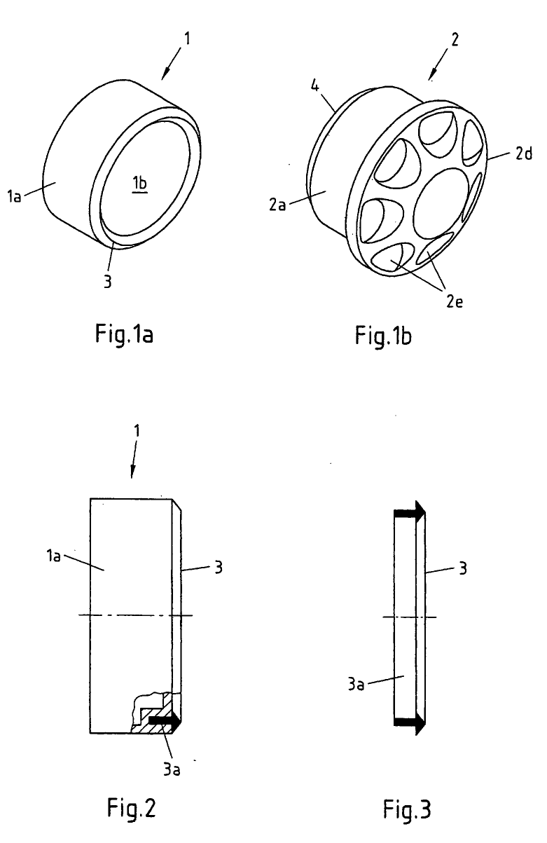

FIG. 1a, b shows a device according to the invention for cleaning aquarium windows with an inner and outer element,

FIG. 2 shows the inner element of the device from FIG. 1 in a partially sectional side view,

FIG. 3 shows an edge element with a cleaning edge according to the invention from FIG. 1a in a sectional view,

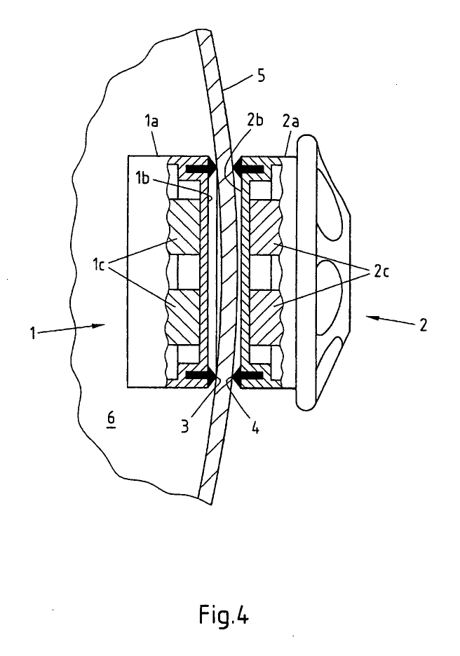

FIG. 4 shows the cleaning of the inside of a spherically curved aquarium window using the device according to the invention from FIG. 1 and

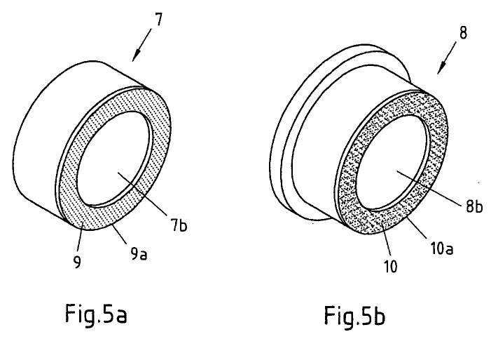

FIG. 5a, 5b show a further embodiment of the device according to the invention for cleaning aquarium windows with an inner and outer element.

FIG. 1 shows the device according to the invention for cleaning aquarium windows, in particular the inside thereof. It comprises an inner element 1 to be positioned on the inside of an aquarium window (FIG. 1a) as well as an outer element 2 to be positioned on the outside of the aquarium window (FIG. 1b). The inner element 1 has a housing 1a which is cylindrical in the present case and which comprises a surface 1b facing the inside of the aquarium window (cf. FIG. 4). According to the invention, the inner element 1 furthermore comprises a cleaning edge 3 arranged on the surface 1b. The cleaning edge 3 is formed smoothly in the present case, but it may also be undulating, jagged or configured with a different type of rough contour. In the present case, the cleaning edge 3 is configured as the upper edge of an edge element 3a with an isosceles triangle-shaped cross-section. The edge element 3a is in turn annular, so the cleaning edge 3 is formed by a closed circular curved line. This ensures that in particular in the case of uniformly spherically curved aquarium window surfaces, the cleaning edge rests flush on the window surface to be cleaned over its entire length, so excellent cleaning results can be achieved. The triangular cross-section of the edge element 3a moreover ensures adequate strength and stability of the cleaning edge even with intensive use of the device according to the invention. In an alternative embodiment (not shown), the sides of the triangular cross-section of the edge element are concavely rounded, so the cross-section of a wiper lip is approximately produced. The edge element 3a shown separately in FIG. 3 is, in the present case, finally manufactured from a polymeric plastics material, in particular of ethylene vinyl acetate or polypropylene.

As shown in FIG. 2 and 4, the edge element 3a sits to fit precisely in an annular groove provided in the housing 1a of the inner element 1.

The outer element 2, according to FIG. 1b, also comprises a cylindrical housing 2a and a disc-shaped grip element 2d, which is in turn provided with a plurality of recessed grips 2e, which improve the handleability of the outer element 2. It is obvious that the recessed grips 2e may likewise be provided in the housing 2a of the outer element itself. In the present case, the outer element 2 also comprises, on its surface 2b facing the outside of the aquarium window to be cleaned (see FIG. 4), an edge 4, which is configured as the upper edge of an edge element 4a. In the present case, the edge elements 3a, 4a of the inner and the outer element 1, 2 are identically configured with regard to geometry and material. It is obviously also possible for the edge element 4a of the outer element 2 to be produced from a different material or with a different cross-sectional geometry, for example a semicircular cross-sectional geometry.

As can be seen, in particular in FIG. 4, the surfaces 1b, 2b of the inner and the outer element 1, 2 are configured completely flat. Likewise it is also possible, however, to form said surfaces 1b, 2b to be at least partially concave. As a result it is possible to also clean aquarium windows with a more strongly curved contour without collisions occurring between the window surface and—depending on the curvature of the window—the inner element 1 or the outer element 2.

The mode of operation of the device according to the invention is now shown in detail in FIG. 4. The outer element 2 and the inner element 1 are positioned on either side of an aquarium window 5 which is spherically curved in the present case. The aquarium window delimits a spherical volume, which is filled with a liquid, in the present case water 6. The two elements 1, 2 in each case have four permanent magnets 1c, 2c, which are arranged next to one another in pairs in the present case, the diametrically opposing magnets having the same polarity in each case. Owing to the mutual magnetic attraction, the inner and the outer element 1, 2 “adhere” to the aquarium window 5 located in between. In this case, the inner element 1 rests with its peripheral cleaning edge 3 flush on the inside of the aquarium window 5 to be cleaned, while the outer element 2 with its edge 4 configured in the present case identically to the cleaning edge 3 also rests flush on the outside of the aquarium window 5.

The cleaning of the inside of the aquarium window 5 is now carried out in that the outer element 2 is guided along the outside of the aquarium window 5, the inner element following the outer element 2 as a result of the acting magnetic forces of attraction and, in the process, stripping off the dirt present on the inside of the aquarium window 5 by means of the cleaning edge 3. A complete and thorough cleaning of the aquarium window 5 is therefore possible owing to the constantly flush abutment of the cleaning edge 3 on the inside of the aquarium window 5.

A further advantageous variant of the invention is not shown, according to which the inner element is constructed in such a way that it floats on the liquid contained in the aquarium as soon as the magnetic attraction between the inner and outer element is interrupted. This buoyancy can just as well be caused by an air chamber provided in the inner element as by a filler material, which has a lower density than the liquid present in the aquarium.

In the embodiment shown in FIG. 5a, the cleaning edge of the inner element 7 is configured as the outer edge 9a of an annular planar portion 9, the planar portion 9 being arranged on the surface 7b of the inner element 7 facing the inside of the aquarium window. The planar portion 9 may in turn consist of various materials, for example a felt-like material, in particular the hook or loop side of a hook-and-loop fastener. In the present case, it is configured as the hook side of a hook-and-loop fastener.

The outer element 8 of the cleaning device is shown in FIG. 5b. On its surface 8b facing the outside of the aquarium window, it also has an annular planar portion 10 with an outer edge 10a, the surface of which is configured in the present case as the loop side of a hook-and-loop fastener.

1. Device for cleaning aquarium windows (5), in particular the inside thereof, comprising an inner element (1) to be positioned on the inside of the aquarium window (5) with a surface (1b) facing the inside of the aquarium window (5), as well as an outer element (2) to be positioned on the outside of the aquarium window (5) with a surface (2b) facing the outside of the aquarium window (5), wherein the inner and outer elements (1, 2) attract one another under the action of magnetic force, so that a movement of the outer element (2) along the aquarium window (5) causes the inner element (1) to follow this movement, wherein at least one cleaning edge (3) is arranged on the surface (1b) of the inner element (1) facing the inside of the aquarium window (5) characterised in that the at least one cleaning edge (3) as the upper edge of an edge element is formed by a closed, round curved line.

2. Device according to claim 1, characterized in that the at least one cleaning edge (3) is undulating or jagged.

3. Device according to claim 1, characterized in that the at least one cleaning edge (3) is curved.

4. Device according to any one of claims 1, characterized in that the at least one cleaning edge (3) is formed by a closed curved line.

5. Device according to claim 4, characterized in that the curved line is round, in particular circular.

6. Device according to any one of claims 1, characterised in that the at least one cleaning edge (3) is configured as the upper edge of an edge element (3a).

7. Device according to claim 6, characterised in that the edge element (3a) has a triangular, in particular an isosceles triangle-shaped cross-section.

8. Device according to any one of claims 1, characterised in that the at least one cleaning edge (3) is manufactured from a polymeric plastics material, in particular ethylene vinyl acetate or polypropylene.

9. Device according to any one of claims 1, characterised in that the cleaning edge is configured as the outer edge of an annular surface portion (9) arranged on the surface (1b) facing the inside of the aquarium window (5).

10. Device according to any one of claims 1, characterised in that an edge (4) according to any one of claims 2 to 9 is also arranged on the surface (2b) of the outer element (2) facing the outside of the aquarium window (5).

11. Device according to any one of claims 1, characterised in that the surface (1b) of the inner element (1) facing the inside of the aquarium window (5) and/or the surface (2b) of the outer element (2) facing the outside of the aquarium window (5) is at least partially concave.

12. Device according to any one of claims 1, characterised in that the inner element (1) is constructed in such a way that it floats on the liquid (6) contained in the aquarium as soon as the magnetic attraction between the inner and outer element (1, 2) is interrupted.

13. Device according to claim 12, characterised in that the inner element (1) comprises an air chamber, which provides the inner element (1) with buoyancy.

14. Device according to claim 12, characterised in that the inner element (1), to acquire buoyancy, contains a material, which has a lower density than the liquid (6) present in the aquarium.

15. Device according to any one of claims 1, characterised in that both the inner element (1) and the outer element (2) are in each case provided with at least one magnet.

16. Device according to claim 15, characterised in that both the inner element (1) and the outer element (2) are in each case provided with four magnets (1c, 2c) arranged next to one another in pairs, the diametrically opposing magnets having the same polarity in each case.

17. Device according to any one of claims 1, characterised in that the inner element (1) contains a magnetisable material.

18. Device according to any one of claims 1, characterised in that the outer element (2) has a housing (2a), which is provided with at least one recessed grip (2e).

19. Method for cleaning aquarium windows (5), in particular the inside thereof, wherein an inner element (1) to be arranged on the inside of the aquarium window (5) and an outer element (2) to be arranged on the outside of the aquarium window (5) are used, the elements (1, 2) attracting one another under the influence of a magnetic force, the outer element (2) being moved along the aquarium window (5) and the inner element (1) following the movement under the influence of the magnetic force, characterised by the use of the device according to any one of claim 1.

20. Method according to claim 19, characterised in that the aquarium window (5) is spherically curved.
